(19) United States
(12) Patent Application Publication
(10) Pub. No.: US 2011/0291062 A1
(43) Pub. Date: Dec. 1, 2011

(54) SELF HELP LADDER AND SECURING DEVICE

(76) Inventor: Brandi Lukes, Catawba, WI (US)

(21) Appl. No.: 13/118,595

(22) Filed: May 31, 2011

Related U.S. Application Data
(60) Provisional application No. 61/349,521, filed on May 28, 2010.
(60) Provisional application No. 61/378,788, filed on Aug. 31, 2010.

(51) Int. Cl. B66D 1/60; B66D 1/36; B23P 11/00; B66D 1/00

(52) U.S. Cl. 254/334; 254/266; 29/428

(57) ABSTRACT

An apparatus and method for one person to safely and easily deploy a tree stand or stand to a pole or a tree.

### CROSS REFERENCE TO RELATED APPLICATIONS

This application claims priority from U.S. provisional application No. 61/349,521 filed 28 May 2010; entitled Self Help Ladder Hoist and Securing Device and U.S. provisional application No. 61/378,788 filed 31 Aug. 2010; entitled Self Help Ladder Hoist and Securing Device. The entire contents of both applications being hereby included by reference and for which benefit of the priority date is claimed.

### FIELD OF THE INVENTION

The present invention is directed toward hoisting devices. More particularly, toward a method and apparatus for providing a device for helping a user to secure a heavy and bulky structure such as a ladder or stand, which is normally too heavy for one user to hoist under their own power and secure the ladder or stand to a tree or other such object. This apparatus is generally directed toward Class 254, Implements or apparatus for applying a pushing or pulling force.

### BACKGROUND OF THE INVENTION

The general purpose of a tree stand is to elevate the user above and out of the plane of sight of animals to be observed. Many times such structures, in order to be substantial enough to carry the weight of at least one user, are bulky and heavy. At times the conditions for a single user can be unsafe with such heavy, unbalanced loads, being at great heights above the head of the user.

Others have provided winch apparatus providing a means for hoisting items from the ground level to a desired height in a tree or pole such as that disclosed in U.S. Pat. No. 5,607,143 to Regal. The problem with such inventions remains how to get the winch to the desired height in the first place, and once there, it either has to remain semi-permanently, or taken back down which obviates the utility of such a system.

Other tree stand hoists, such as that disclosed in U.S. Pat. No. 7,458,563 to Liu teaches a tree stand hoist which includes a holder frame with stop bars and harnesses for fastening to a tree, a cable pulley assembly provided with a rope for fastening to the tree at a high place. Again the user has to rely on first gaining access to a high branch to provide an anchor point for the hoist.

Similar constraints can be raised with hoists such as that disclosed in U.S. Pat. No. 6,739,964 to Gearhart, which teaches a portable V-shaped tree- or pole-mounted deer hoist is made up of a boom having a front bracket, a rear retaining bar and a separate bracket-mounted winch. The winch bracket is strapped onto the tree or pole at a location on the tree or pole below the hoist bracket. A rope connected at one end to the winch is connected at the other end to a gambrel and is used to raise or lower an animal carcass using a pulley that is attached to the front tip of the V-shaped front boom bracket.

One of the problems common to all the apparatus discussed is associated with getting the equipment into a high position in the first place, which is not addressed by the prior art. Not only does the present invention provide an alternative to the prior art, but can be used in conjunction with each of the references sighted to further improve their effectiveness.

### SUMMARY OF THE INVENTION

A typical embodiment for the present invention can be provided as a relatively light and easily maneuvered apparatus for providing a leverage point for getting a heavy structure into an upright position against a vertical or upright beam member such as a tree, pole or the like. The apparatus secures the structure sufficiently that the user can access the structure to attach it more permanently to the vertical or upright beam member as desired.

### OBJECTS AND ADVANTAGES

It is an advantage of the present invention to create an apparatus for getting bulky equipment into a high position relative to the user.

It is a further advantage of the present invention to provide a safe means for raising a ladder next to a tree.

It is a further advantage of the present invention to allow the hanging of a tree-stand into a tree.

The foregoing has outlined rather broadly the features and technical advantages of this invention so that those skilled in the art may better understand the detailed description that follows.

Those skilled in the art will appreciate that they may readily use the conception and the specific embodiments disclosed as a basis for modifying or designing other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

FIG. 1 shows a plan view of a Ladderbuddy™ (self help ladder hoist and securing device) corresponding to steps 1 and 2;

FIG. 2 shows a schematic view of a Ladderbuddy™ and a stand abutted to a tree corresponding to step 3;

FIG. 3 shows a schematic view of a Ladderbuddy™ and a stand abutted to a tree corresponding to step 4;

FIG. 4 shows a schematic view of a Ladderbuddy™ and a stand corresponding to step 4;

FIG. 5 shows a schematic view of a Ladderbuddy™ being used to raise a stand corresponding to step 5;

FIG. 6 shows a schematic view of a Ladderbuddy™ having raised a stand and secured it to a tree corresponding to steps 6-8;

FIG. 7 shows a plan view of an alternate embodiment of the Ladderbuddy™;

FIG. 8 shows a schematic view of an alternate embodiment of the Ladderbuddy™ and a stand corresponding to step 4;

FIG. 9 shows a schematic view of the embodiment of FIG. 8 corresponding to step 5;

FIG. 10 shows a schematic view of a preferred third embodiment of the Ladderbuddy™ and a stand corresponding to step 4;

FIG. 11 shows a schematic view of the embodiment of FIG. 10 corresponding to step 5.

### DETAILED DESCRIPTION

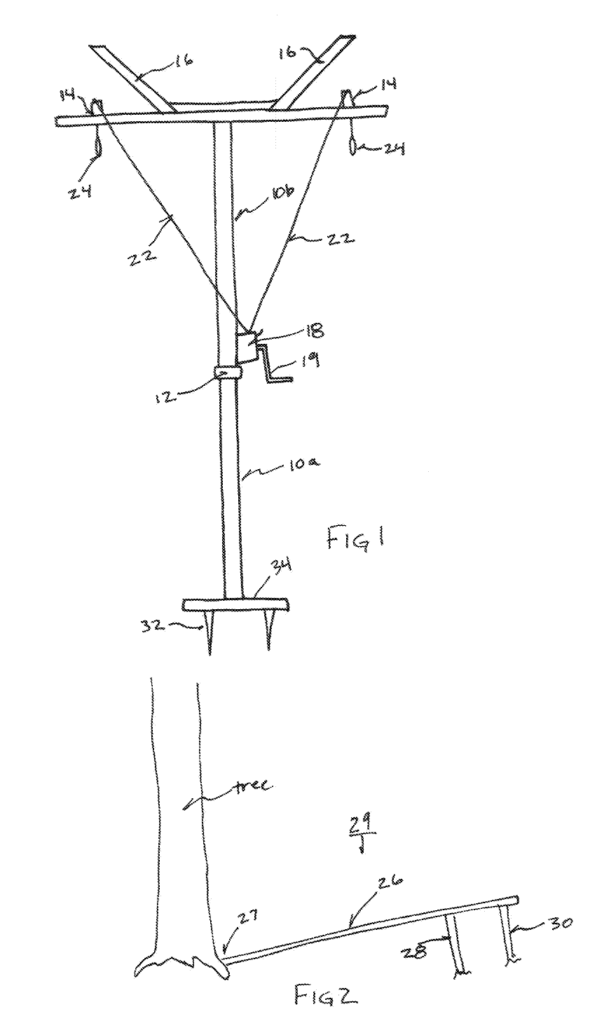

FIG. 1 shows at least one extension rod (10a and or 10b) or a post, in this case two sections of black iron pipe being joined by a union (12). A winch (18) having two tensing members (22) which can comprise wire, cable, rope and the like having a diameter of approximately ⅛ to ¼ inch and wrapped about a spool with a crank (19), which can be manual or electronic, is located along the length of the rod (10) such that a user can have easy access during operation, about 4 to 5 feet from the bottom. Additionally a cleat (32) or series of cleats can be located at the bottom of the rod (10a) on a platform (34) for ease in securing the base. Stabilizing members (16) or guardrails can be provided and sized to provide lateral security to an average sized tree is also provided. Cable guides and pulleys (14) can be located at convenient locations on the stabilizing members (16) and connected and actuated at one end by the winch (18) with the other end having connecting members (24) on the other. The connecting members (24) can be of several different types, but a typical carabineer type connector is preferred.

FIG. 7 shows an alternate and preferred embodiment to the present invention in which one tensing member (22) is situated through a first pulley (14a), a block and tackle (40) type arrangement generally comprising a first pulley (40a) and a second pulley (40b) which is known in the art, is associated with the tensing member (22) which then situated through a second pulley (14b). Both the first and second pulleys (14a)(14b) are preferred to be mounted to a cross beam (17) roughly equal distance from the extension rod (10b) to assure balanced operation. Additionally one or more spikes (42) can be situated near the top of the extension rod (10b) to provide a hold to the tree or other vertical member.

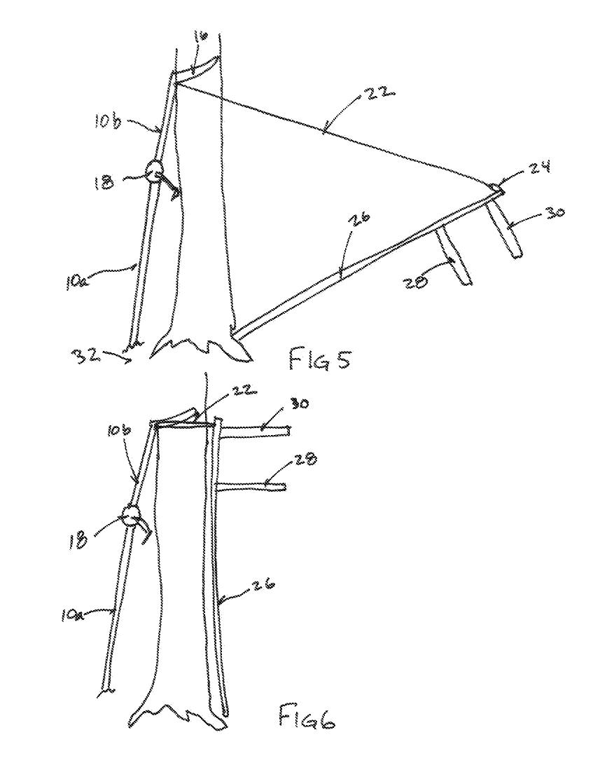

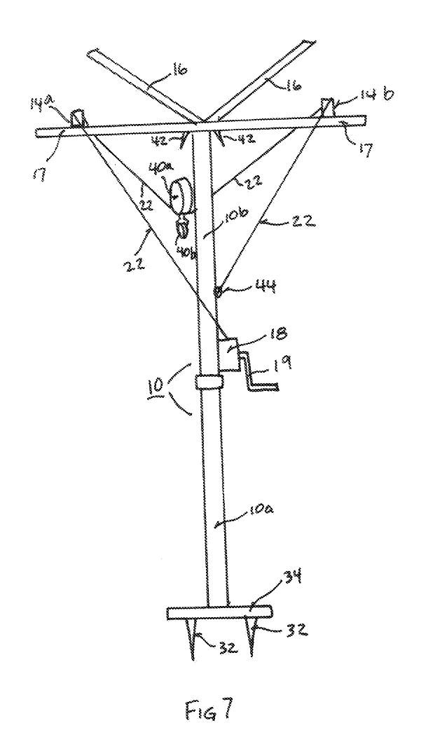

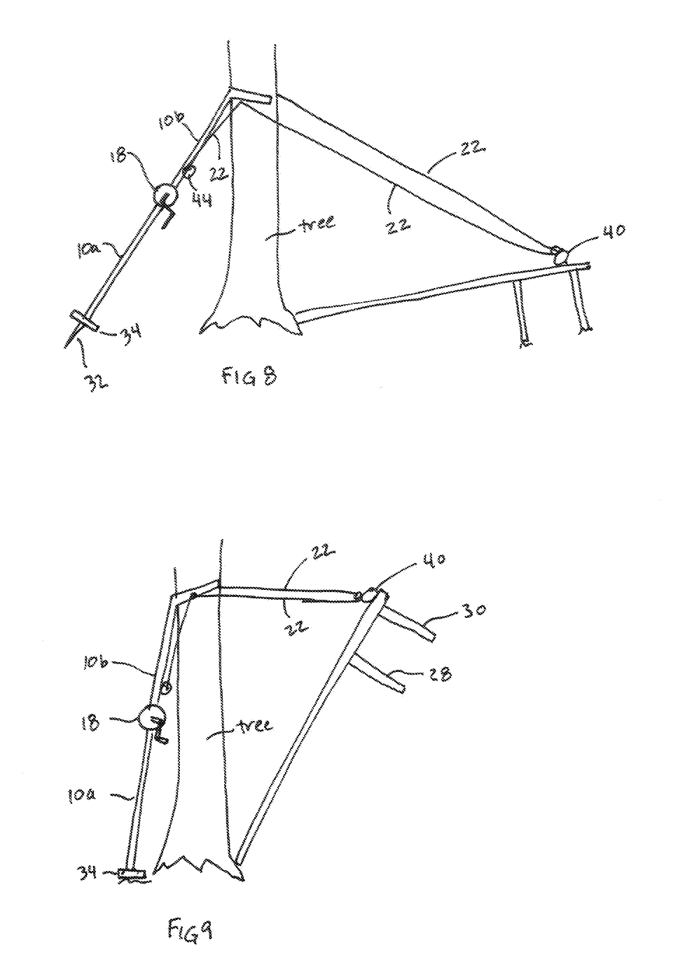

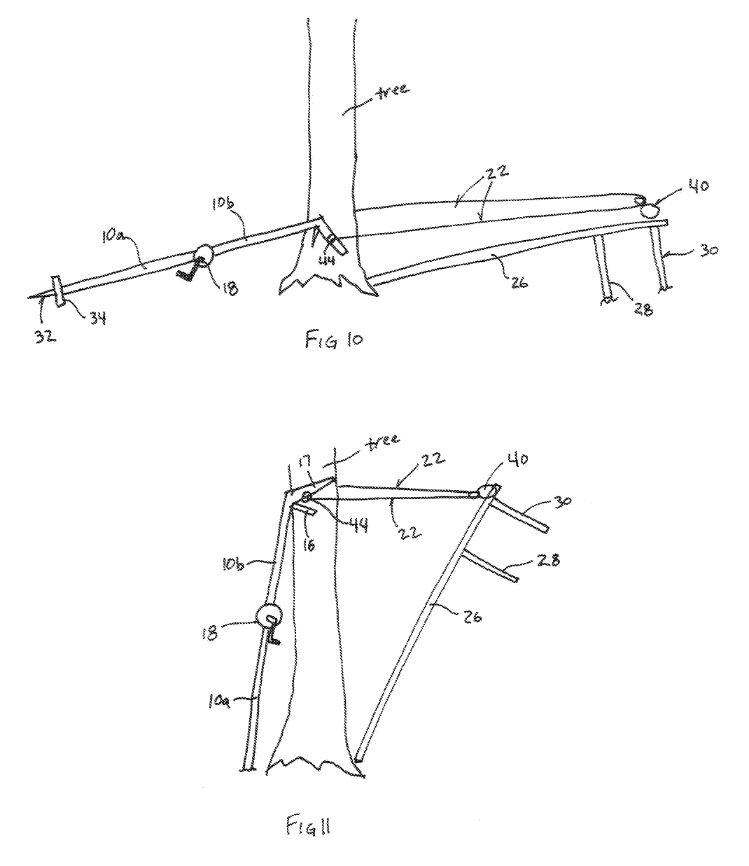

It has been found as shown in FIGS. 8, 9, 10, and 11, that the addition of the block and tackle (40) to the embodiment of FIGS. 1-6 provides an unexpected self balancing feature to the present invention. FIGS. 10 and 11 show an embodiment in which the second pulley (14b) has been removed and the anchor point (44) is situated on the cross beam (17) in order to simplify design and eliminate excess materials. It is viewed that the embodiments of FIGS. 8,9 and 10,11 are roughly functional equivalent structures.

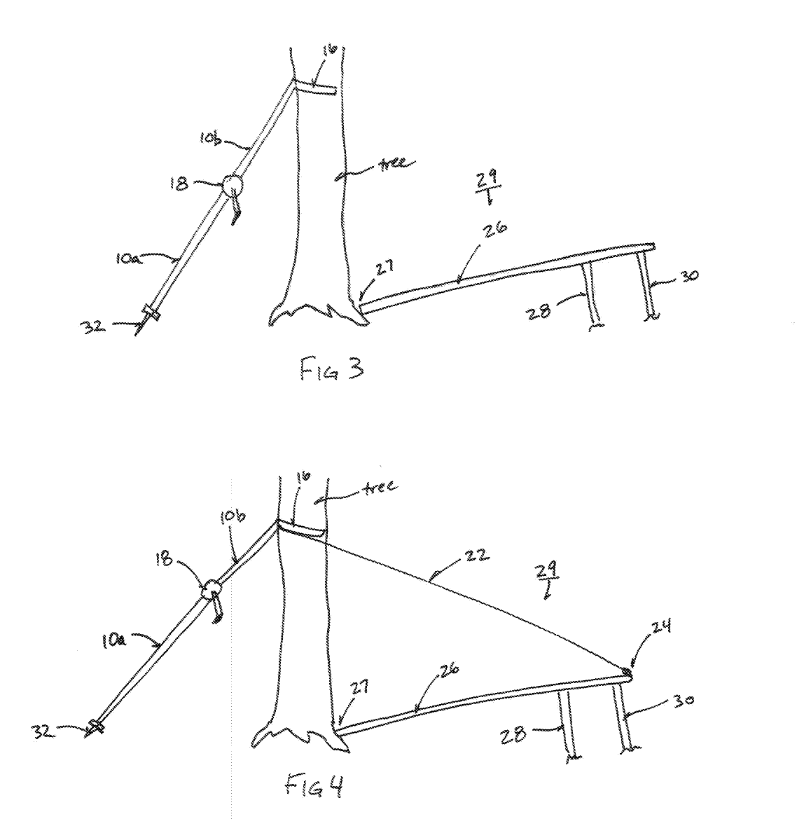

The assembly can be deployed in a series of steps as illustrated in FIGS. 2 through 6.

Steps for a typical use of one embodiment can include the following;

Locate a suitable upright support beam such as a tree or a pole firmly attached to the ground at a base. An example of a suitable girth for a support beam or tree should be 18 to 24 inches minimum circumference.

Provide a structure (29) which can comprise a floor member (28) and a guardrail member (30) and at least one post (26) to form a ladder-stand, platform, observation deck or the like. The structure (29) having a predetermined position near the top, or opposite the base platform (34) for receiving means for hooking a tensing member (22) or cable having connecting members (24).

Lay the structure (29), such as an assembled ladder-stand, front end down with the bottom base (27) of the stand against the base of the upright support beam.

Assemble the Ladderbuddy™ to full extension (if needed), typically by securely joining the extension rods (10a) (10b) in a tandem arrangement by means of a union (12) such as a screw or quick release coupling.

Position the Ladderbuddy™ squarely to the upright support member such that the stabilizing members (16) of the Ladderbuddy™ are opposite the side of the upright member where the structure (29) is located. Roughly a 40° to 60° angle between the ground and the extension rods (10a) (10b) is preferred.

Release the winch (18), which should generally be located about shoulder height to the user on the extension rods (10a) (10b), and draw out the tensing member(s) (22) and attach them to the connecting member (24) on the structure. In an alternate embodiment, the tensing member (22) is routed across a first pulley (14a) through a block and tackle (40) across a second pulley (14b) and connected to an anchor point (44). The block and tackle (40) is connected with the connecting member (24) at (40b).

For safety reasons, it is preferred that the user stand behind the Ladderbuddy™ and adjust Ladderbuddy™ such the angle between the extension rod (10) and the ground is adjusted to approximately 75° to 85°. Actuate the lever (19) on the winch (18), typically by clicking it into place, and begin to wind the tensing member (22).

Once the structure (29) is fully raised and securely abutted to the upright member, check for weight bearing capability and ease of climbing, further check the tensors (22) between the Ladderbuddy™ and the structure (29) to assure they are snug.

Secure the structure to the upright member such that it can remain attached independently of the Ladderbuddy™, then unhook the tensor (22) between the Ladderbuddy™ and the structure.

Return to the base of the Ladderbuddy™ and wind any remaining tensor (22) cable into the winch (18), and disassemble any remaining connections as desired.

To disassemble or remove the structure from the upright beam member reverse the process.

### CONCLUSION, RAMIFICATIONS, AND SCOPE

While the above description contains much specificity including the disclosure of a preferred embodiment designed to satisfy best mode requirements of 35 U.S.C. 112 paragraph 1. These should not be construed as limitations on the scope of the invention, but rather as an exemplification primarily of one preferred embodiment with several additional modes designed to better teach the broader concept thereof. Many other variations are possible. Accordingly, the scope of the invention should be determined not by the embodiment(s) illustrated, but by the appended claims and their legal equivalents.

We claim:

1. A method for deploying a structure securely to an upright support beam, the method comprising:
(a) locating a suitable upright support beam;
(b) providing an assembly comprising at least one sturdy extension rod being in connection with a winch, the winch having at least one tensing member projecting there-from, the tensing member being arranged to project from a cross beam located projecting orthogonally from the extension rod and located at or near the top portion of the extension rod;
(c) providing a connecting member in relation with the tensing member;
(d) providing a structure comprising a rigid support member having a bottom end and a top end;
(e) arranging the bottom end of the rigid support member to align with the base of the upright support beam;
(f) connecting the tensing member in the vicinity of the top end of the support member;
(g) activating the winch in such a way that the top end of the structure is compelled to abut to the support beam.

2. The method in accordance with claim 1 further comprising stabilizing members securely fastened to the cross beam.

3. The method in accordance with claim 2 wherein the sturdy extension rod comprises a plurality of extension rods joined in a tandem arrangement.

4. The method in accordance with claim 3 further comprising the tensing member being connected to an anchor point and being operated in connection with a block and tackle.

5. The method in accordance with claim 3 wherein said deployment is accomplished at the ground level.

6. The method in accordance with claim 4 further comprising a motorized winch.

7. The method in accordance with claim 4 further comprising at least one spike substantially at the top of the extension rod.

8. The method in accordance with claim 4 wherein said assembly can be disengaged and removed once the structure is secured to the upright support beam.

9. The method in accordance with claim 7 further comprising disassembly steps.

10. The method for deploying a ladder stand or stand securely to a pole or a tree comprising:
(a) providing an assembly comprising at least one sturdy extension rod having an anchor point and the extension rod further being in connection with a winch;
(b) the winch having at least one tensing member projecting therefrom, the tensing member being arranged to project from at least one cross member located at or near the top portion of the rod;
(c) providing a block and tackle in connection with the tensing member;
(d) providing an anchor point mounted to the extension rod;
(e) providing a stand and associating the tensing member with the stand and connecting the tensing member to the anchor point, in such a way that when the winch is activated the stand is compelled to abut to the tree in a balanced way
(f) secure the stand to the tree.

11. The method in accordance with claim 10 wherein the extension rod comprises a plurality of rods joined in tandem.

12. The method in accordance with claim 11 further comprising a motorized winch.

13. The method in accordance with claim 12 further comprising a cleat at a bottom end of the sturdy extension rod.

14. An apparatus for hoisting a tree stand for attachment to a tree comprising:
(a) an assembly comprising at least one sturdy extension rod, the rod being in connection with a winch, the winch having a tensing member projecting there from;
(b) the tensing member being arranged to project from a cross beam projecting orthogonally from and located substantially at the top of the extension rod;
(c) a connecting member in relation with the tensing member.
